(19) United States
(12) Patent Application Publication
(10) Pub. No.: US 2011/0314198 A1
(43) Pub. Date: Dec. 22, 2011

(54) Wireless Peripheral Chips, Host Devices and Multi-Interface Communication Apparatuses

(75) Inventors: Hsien-Chang Liu, Jhushan Township (TW); Yun-Chang Chang, Hsinchu City (TW)

(73) Assignee: MEDIATEK INC., Hsin-Chu (TW)

(21) Appl. No.: 12/817,409

(22) Filed: Jun. 17, 2010

(51) Int. Cl. G06F 13/24

(52) U.S. Cl. 710/260

(57) ABSTRACT

A wireless peripheral chip operable to connect to a host device is provided. The wireless peripheral chip includes a first wireless communication module providing a first wireless communication service for the host device and a second wireless communication module providing a second wireless communication service for the host device. The first wireless communication module and the second wireless communication module share at least one interrupt signal for communicating with the host device.

### BACKGROUND OF THE INVENTION

1. Field of the Invention

The invention relates to a communication apparatus, and more particularly to a communication apparatus with reduced number of interrupt pins.

2. Description of the Related Art

With the development of wireless communications technology, mobile electronic devices may be provided with more than one wireless communications service, such as Bluetooth, Wireless Fidelity (WiFi), Global Positioning System (GPS) and so on. Modules for providing the wireless communications services may be implemented as a single chip, or integrated into a combo chip as an SoC (system on chip). However, in either case, the number of transmission lines or pins increases as the number of integrated wireless communications modules increases. When the number of transmission lines or pins increases, the chip area and hardware cost also increase accordingly.

Therefore, a communication apparatus with a greatly reduced number of transmission lines or pins is highly required.

### BRIEF SUMMARY OF THE INVENTION

Wireless peripheral chip, host device and multi-interface communication apparatus are provided. An embodiment of a wireless peripheral chip operable to connect to a host device comprises a first wireless communication module arranged to provide a first wireless communication service for the host device and a second wireless communication module arranged to provide a second wireless communication service for the host device. The first wireless communication module and the second wireless communication module share at least one interrupt signal for communicating with the host device.

Another embodiment of a host device operable to connect to a wireless peripheral chip is provided. The wireless peripheral chip comprises a processor, a first wireless communication module and a second wireless communication module. The first and second wireless communication modules share at least one interrupt signal for communicating with the host device. The host device comprises a first driver module and a second driver module, arranged to respectively drive the first and second wireless communication modules according to the shared interrupt signal.

Another embodiment of a multi-interface communication apparatus operable to connect to a host device comprises a first wireless communication module with a first communication interface conforming to a first wireless communication protocol and arranged to provide a first wireless communication service for the host device, and a second wireless communication module with a second communication interface conforming to a second wireless communication protocol different from the first wireless communication protocol and arranged to provide a second wireless communication service for the host device. The first wireless communication module and the second wireless communication module share at least one interrupt signal for communicating with the host device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a communication apparatus according to an embodiment of the invention;

FIG. 2 shows a message flow for processing the shared interrupt signal according to an embodiment of the invention;

FIG. 3 shows a communication apparatus according to another embodiment of the invention; and

FIG. 4 shows a communication apparatus according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

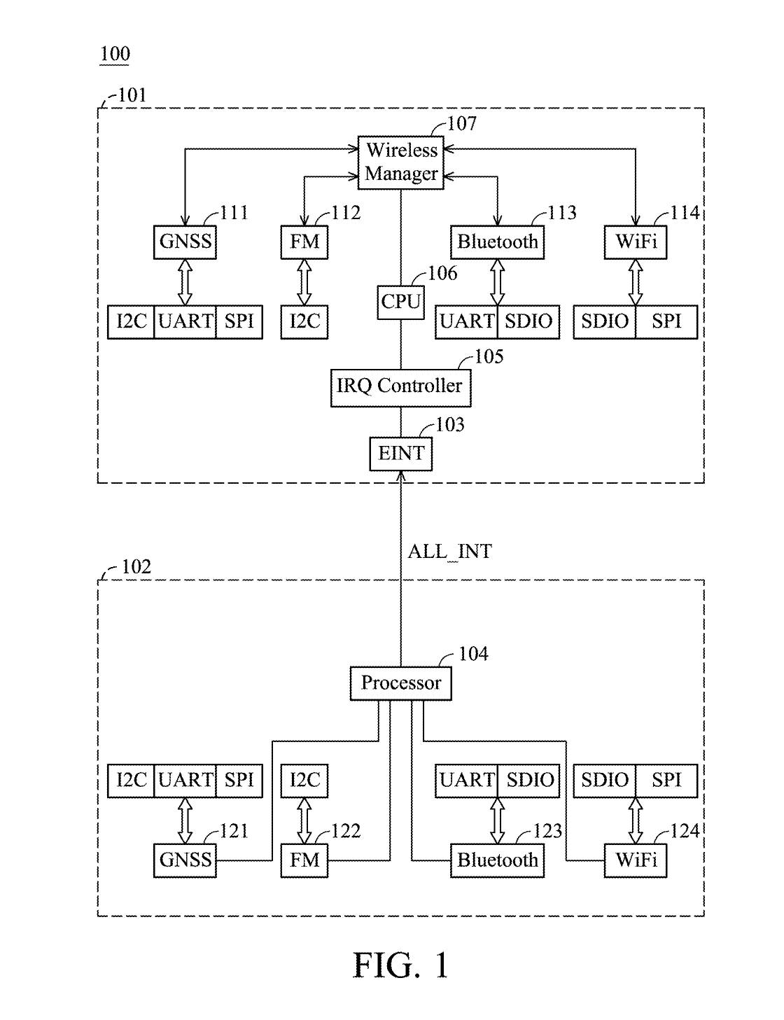

FIG. 1 shows a communication apparatus according to an embodiment of the invention. The communication apparatus 100 comprises a host device 101 and a plurality of peripheral wireless communication modules for providing different wireless communication services to the host device 101. According to the embodiment of the invention, the host device 101 may comprise a baseband chip of a mobile device (ex, mobile phone, PDA, personal computer, laptop), the peripheral wireless communication modules may comprise a Global Navigation Satellite System (GNSS) module 121, a Frequency Modulation (FM) radio module 122, a Bluetooth module 123 and a Wireless Fidelity (WiFi) module 124 as shown in FIG. 1, where each peripheral wireless communication module may have a communication interface conforming to the corresponding wireless communication protocol to communicate with a peer wireless communication module. For example, the GNSS module 121 has an Inter-Integrated Circuit (I2C) interface, an Universal Asynchronous Receiver/Transmitter (UART) interface and a Serial Peripheral Interface (SPI), and may select one of them to communicate with the host device 101. The Bluetooth module 123 has an UART interface and a Secure Digital Input/Output (SDIO) interface, and may select one of them to communicate with the host device 101. In the embodiments of the invention, each wireless communication module may be implemented as a single chip for providing different wireless communication services, or may be integrated into a combo chip (i.e., a system on chip (SoC)), such as the wireless peripheral chip 102 shown in FIG. 1. Note that the invention concept may be applied to both the multi-interface communication modules structure (i.e. each wireless communication module implemented as a single chip) and the combo chip structure (i.e., the SoC), and should not be limited to either one.

There are mainly two purposes to invoke an interrupt signal, one is to wake up the host device and the other one is to notify the host device of events. When the host device is in power save mode, the peripheral wireless communication module may wake up the host device in low-power mode via the interrupt signal. On the other hand, because most of the sub-systems of the peripheral wireless communication modules work in slave mode, the peripheral wireless communication modules may notify the host device that the slave device has an event to the master device (host device) via the interrupt signal. For a conventional communication apparatus having a plurality of wireless communication modules configured therein, each wireless communication module is equipped with a dedicated interrupt pin to communicate with the host device. However, the number of interrupt pins increases as the number of peripheral wireless communications modules increases, causing huge power consumption and chip area.

Therefore, a novel hardware, firmware and/or software structure of a communication apparatus with at least one shared interrupt signal and at least one shared interrupt pin is proposed to solve the above-mentioned problems. Further, in the embodiment shown in FIG. 1, only one interrupt pin is required for the peripheral wireless communications modules.

As shown in FIG. 1, the communication apparatus 100 comprises a plurality of peripheral wireless communication modules, including the GNSS module 121, the FM radio module 122, the Bluetooth module 123 and the Wireless Fidelity (WiFi) module 124. According to an embodiment of the invention, the peripheral wireless communication modules may communicate with the host device 101 by using a shared interrupt signal ALL_INT. To be more specific, according to an aspect of the invention, the peripheral wireless communication modules may share an interrupt pin EINT 103, and the shared interrupt signal is transmitted to the host device 101 via the shared interrupt pin EINT 103. According to another aspect of the invention, the peripheral wireless communication modules may also share at least one interrupt interface, and the shared interrupt signal is transmitted to the host device 101 via the shared interrupt interface.

The communication apparatus 100 (or the wireless peripheral chip 102 for a combo chip structure) may further comprise a processor 104 arranged to receive the individual interrupt signals from the peripheral wireless communication modules, and generate the shared interrupt signal ALL_INT according to the individual interrupt signals. In addition, the communication apparatus 100 may further comprise an interrupt request controller (IRQ controller) 105, a central processing unit (CPU) 106, a wireless manager 107 and a plurality of driver modules 111, 112 . . . to 114. According to one embodiment of the invention, the shared interrupt signal ALL_INT is passed to the host device 101 via the shared interrupt pin EINT 103. The shared interrupt pin EINT 103 may be an interrupt pin equipped with the CPU 106. The IRQ controller 105 collects the internal interrupt signals generated by the modules inside of the host device 101 and the external interrupt signals generated by the external modules. The CPU 106 receives the collected interrupt signals, and determines the interrupt service routine (ISR) corresponding to the interrupt signal by looking up a table comprising information regarding a plurality of registered ISRs.

When the interrupt signal received by the CPU is determined to be an external interrupt signal, the corresponding ISR may be invoked and executed by the wireless manager 107. The wireless manager 107 is arranged to manage the shared interrupt signal ALL_INT came from the external modules. According to an embodiment of the invention, the processor 104 may further record information regarding which wireless communication module is an interrupt source of the shared interrupt signal ALL_INT. In this manner, the wireless manager 107 may query the processor 104 as to which wireless communication module is the interrupt source of the shared interrupt signal, and instruct the driver module corresponding to the interrupt source to communicate with the interrupt source. The driver modules 111, 112 . . . to 114 are arranged to drive the corresponding wireless communication modules 121, 122 . . . to 124 via the corresponding driving signals. In another aspect, the processor 104 may reply to a query sent by the host device 101 after the shared interrupt signal is received by the host device 101 which wireless communication module is the interrupt source of the shared interrupt signal, and then the interrupt source communicates with a respective driver module in the host device 101 in response to the driving signal. As an example, when the GNSS module 121 is the interrupt source, the wireless manager 107 may instruct the GNSS driver module 111 to drive the GNSS module 121 and communicate with the GNSS module 121 (e.g. data transmission may begin). According to another embodiment of the invention, the wireless manager 107 may also directly query the plurality of wireless communication modules 121, 122 . . . to 124 which one is the interrupt source of the shared interrupt signal ALL_INT, and instruct the driver module corresponding to the interrupt source to communicate with the interrupt source via the corresponding driving signals.

Note that in the embodiments of the invention, each peripheral wireless communication module may communicate with the host device 101 via the corresponding dedicated transmission interface. As shown in FIG. 1, the GNSS module 121 may communicate with the host device 101 via the I2C bus, the UART bus, or the SPI bus. The FM radio module 122 may communicate with the host device 101 via the I2C bus. The Bluetooth module 123 may communicate with the host device 101 via the UART bus or the SDIO bus. The WiFi module 124 may communicate with the host device 101 via the SDIO bus or the SPI bus. The structure shown in FIG. 1 may be regarded as a multi-interface communication module structure.

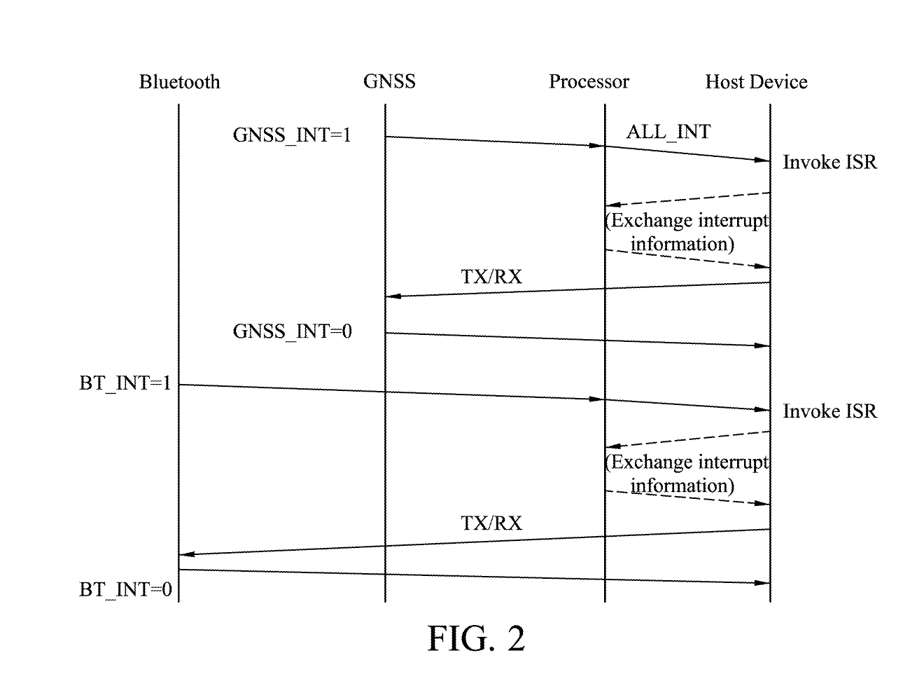

FIG. 2 shows a message flow for processing the shared interrupt signal according to an embodiment of the invention. When the GNSS module has some data to be transmitted to the host device 101, the flag GNSS_INT may be set to ‘1’ and the GNSS interrupt signal may be sent to the processor 104. The processor 104 may generate the shared interrupt signal ALL_INT for the interrupt source—the GNSS module, and send the shared interrupt signal ALL_INT to the host device 101. Next, the host device 101 may invoke the corresponding ISR to handle to the shared interrupt signal ALL_INT. The interrupt information may be exchanged between the host device 101 and the processor 104 or the wireless communication modules so as to find out which wireless communication module is the interrupt source. When the interrupt source is found out, the flag GNSS_INT may be set to ‘0’. After that, data transmission or reception (TX/RX) may begin between the GNSS module 121 and the host device 101 via the transmission interface I2C, UART or SPI. Afterward, when another wireless communication module, such as the Bluetooth module 123, has some data to be transmitted to the host device, the flag BT_INT may be set to ‘1’ and the Bluetooth interrupt signal may be sent to the processor 104. The processor 104 may generate the shared interrupt signal ALL_INT for the interrupt source—the Bluetooth module, and send the shared interrupt signal ALL_INT to the host device 101. The message flow for processing the interrupt signal of the Bluetooth module is similar to the GNSS module. Reference descriptions may be made to the GNSS module and are omitted here for brevity.

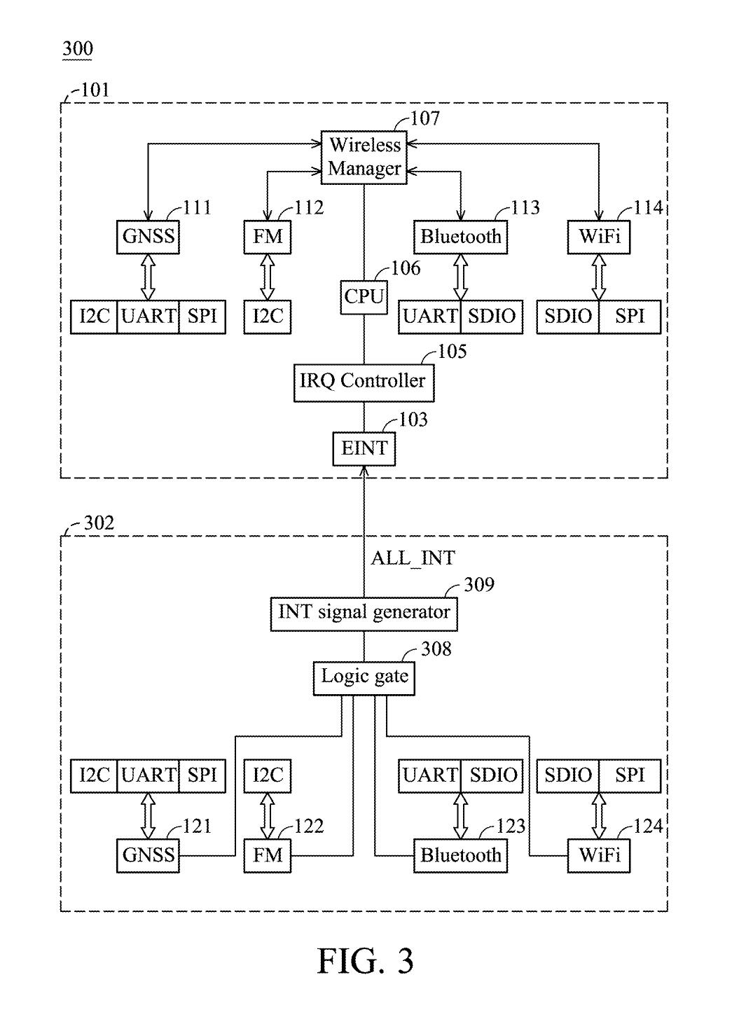

FIG. 3 shows a communication apparatus according to another embodiment of the invention. As shown in FIG. 1 and FIG. 3, the same symbols represent the same elements. Therefore, reference may be made to FIG. 1 and the corresponding paragraphs, and the descriptions for the same elements are omitted here for brevity. In the embodiment of the invention, the processor may comprise at least two hardware elements: a logic gate 308 and an interrupt signal generator 309. The logic gate 308 receives the individual interrupt signals from the peripheral wireless communication modules 121, 122 . . . to 124, and generates an output signal representing a logic operation result of the individual interrupt signals. As an example, the logic operation may be an OR operation. Note that the logic operation may also be chosen from or combined by other types of logic to achieve the similar result and the invention should not be limited thereto. The interrupt signal generator 309 may generate the shared interrupt signal ALL_INT according to the output signal received from the logic gate 308. According to the embodiments of the invention, the interrupt signal generator 309 is capable of generating multiple types and shapes, for example, the square wave, triangle wave, edge trigger . . . etc., of shared interrupt signal ALL_INT according to the requirements of different host devices. After the interrupt signal generator 309, the shared interrupt signal ALL_INT may be transmitted to the host device via the shared interrupt pin EINT 103 or the shared interrupt interface as previously described. The following steps for the host device 101 to process the shared interrupt signal ALL_INT is similar to the embodiments shown in FIG. 1 and the corresponding paragraphs, and are omitted here for brevity. Note that as previously described, the invention concept may be applied to both the multi-interface communication modules structure (i.e. each wireless communication module implemented as a single chip) and the combo chip structure (i.e., the wireless peripheral chip 302 implemented as an SoC), and should not be limited to either one.

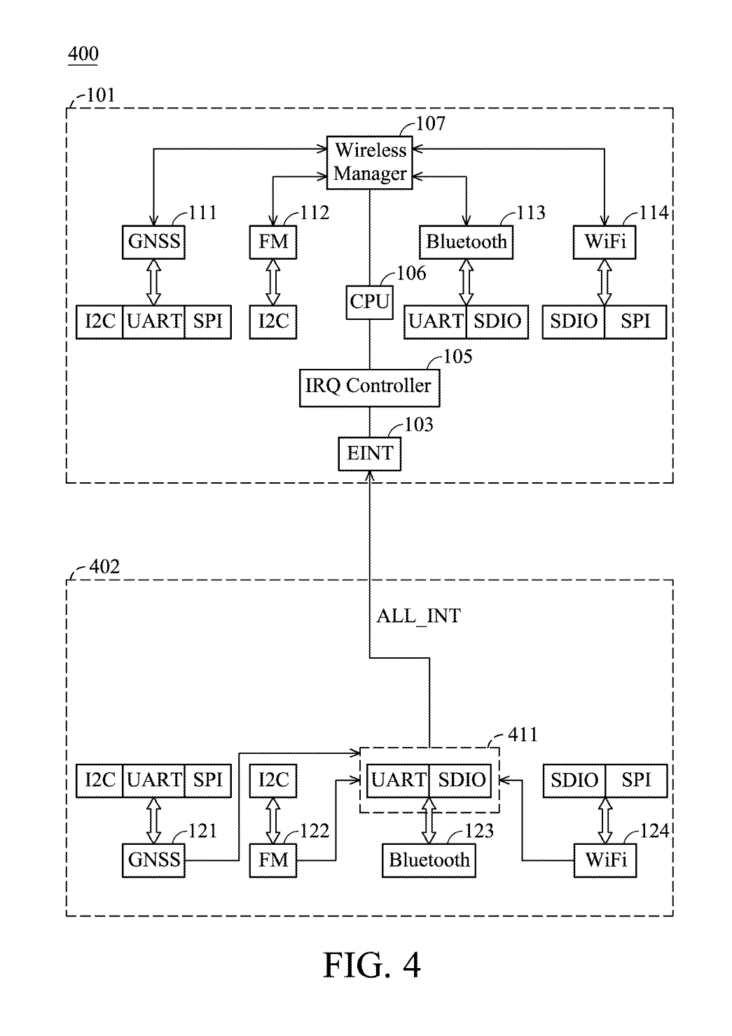

FIG. 4 shows a communication apparatus according to yet another embodiment of the invention. As shown in FIG. 1 and FIG. 4, the same symbols represent the same elements. Therefore, reference may be made to FIG. 1 and the corresponding paragraphs, and the descriptions for the same elements are omitted here for brevity. In the embodiment of the invention, the shared interrupt signal ALL_INT may be generated and transmitted via a specific transmission interface instead of the processor 104. As an example shown in FIG. 4, the transmission interface module 411 may comprise at least an SDIO bus. The SDIO bus may be arranged to receive the individual interrupt signals from different wireless communication modules, and generate the shared interrupt signal ALL_INT according to the received individual interrupt signals. The shared interrupt signal ALL_INT may next be transmitted to the host device 101 via the shared interrupt pin EINT 103 or the shared interrupt interface as previously described. The following steps for the host device to process the shared interrupt signal ALL_INT is similar to the embodiments shown in FIG. 1 and the corresponding paragraphs, and are omitted here for brevity. Note that in the embodiment of the invention, each peripheral wireless communication module may still communicate with the host device 101 via the corresponding dedicated transmission interface as shown in FIG. 4. Thereby, the structure shown in FIG. 4 may still be regarded as a multi-interface communication module structure. Note that as preciously described, the invention concept may be applied to both the multi-interface communication modules structure (i.e. each wireless communication module implemented as a single chip) and the combo chip structure (i.e., the wireless peripheral chip 402 implemented as an SoC), and should not be limited to either one.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless peripheral chip operable to connect to a host device, comprising:
a first wireless communication module, arranged to provide a first wireless communication service for the host device; and
a second wireless communication module, arranged to provide a second wireless communication service for the host device;
wherein the first wireless communication module and the second wireless communication module share at least one interrupt signal for communicating with the host device.

2. The wireless peripheral chip as claimed in claim 1, wherein the first wireless communication module and the second wireless communication module share at least one interrupt pin, and the shared interrupt signal is transmitted from the wireless peripheral chip to the host device via the shared interrupt pin.

3. The wireless peripheral chip as claimed in claim 1, wherein the first wireless communication module and the second wireless communication module share at least one interrupt interface, and the shared interrupt signal is transmitted from the wireless peripheral chip to the host device via the shared interrupt interface.

4. The wireless peripheral chip as claimed in claim 1, further comprising:
a processor, arranged to receive a first interrupt signal from the first wireless communication module and a second interrupt signal from the second wireless communication module, and generate the shared interrupt signal according to the first and the second interrupt signals.

5. The wireless peripheral chip as claimed in claim 1, further comprising:
a first transmission interface; and
a second transmission interface;
wherein the first wireless communication module transmits data to the host device via the first transmission interface and the second wireless communication module transmits data to the host device via the second transmission interface.

6. The wireless peripheral chip as claimed in claim 4, wherein the processor further records information regarding which wireless communication module is an interrupt source of the shared interrupt signal.

7. The wireless peripheral chip as claimed in claim 6, wherein the processor replies to a query sent by the host device after the shared interrupt signal is received by the host device which wireless communication module is the interrupt source of the shared interrupt signal, and then the interrupt source communicates with a respective driver module in the host device in response to a driving signal.

8. The wireless peripheral chip as claimed in claim 1, wherein the first and second wireless communication modules are selected from a group comprising a Bluetooth module, a Wireless Fidelity (WiFi) module, a Global Navigation Satellite System (GNSS) module and a Frequency Modulation (FM) radio module.

9. A host device operable to connect to a wireless peripheral chip, and the first and second wireless communication modules sharing at least one interrupt signal for communicating with the host device, the host device comprising:
a first driver module and a second driver module, arranged to respectively drive a first and a second wireless communication modules of the wireless peripheral chip;
wherein the first and second wireless communication modules share at least one interrupt signal for communicating with the host device.

10. The host device as claimed in claim 9, further comprising a wireless manager arranged to, after receiving the shared interrupt signal, query the processor of the wireless peripheral chip as to which wireless communication module is the interrupt source of the shared interrupt signal, and instruct the driver module

11. The host device as claimed in claim 9, further comprising a wireless manager arranged to, after receiving the shared interrupt signal, query at least the first and second wireless communication modules as to which one is the interrupt source of the shared interrupt signal, and instruct the driver module corresponding to the interrupt source to communicate with the interrupt source.

12. A multi-interface communication apparatus operable to connect to a host device, comprising:
a first wireless communication module with a first communication interface conforming to a first wireless communication protocol, arranged to provide a first wireless communication service for the host device; and
a second wireless communication module with a second communication interface conforming to a second wireless communication protocol different from the first wireless communication protocol, arranged to provide a second wireless communication service for the host device;
wherein the first wireless communication module and the second wireless communication module share at least one interrupt signal for communicating with the host device.

13. The multi-interface communication apparatus as claimed in claim 12, wherein the first and second wireless communication modules share at least one interrupt pin, and the shared interrupt signal is transmitted from the first or second wireless communication module to the host device via the shared interrupt pin.

14. The multi-interface communication apparatus as claimed in claim 12, wherein the first and second wireless communication modules share at least one interrupt interface, and the shared interrupt signal is transmitted from the first or second wireless communication module to the host device via the shared interrupt

15. The multi-interface communication apparatus as claimed in claim 12, further comprising:
a processor, arranged to receive a first interrupt signal from the first wireless communication module and a second interrupt signal from the second wireless communication module, and generate the shared interrupt signal according to the first and the second interrupt signals.

16. The multi-interface communication apparatus as claimed in claim 12, further comprising:
a first transmission interface; and
a second transmission interface;
wherein the first wireless communication module transmits data to the host device via the first transmission interface and the second wireless communication module transmits data to the host device via the second transmission interface.

17. The multi-interface communication apparatus as claimed in claim 15, wherein the processor further records information regarding which wireless communication module is an interrupt source of the shared interrupt signal.

18. The multi-interface communication apparatus as claimed in claim 15, wherein the processor replies to a query sent by the host device after the shared interrupt signal is received by the host device which wireless communication module is the interrupt source of the shared interrupt signal, and then the interrupt source communicates with a respective driver module in the host device in response to a driving signal.

19. The multi-interface communication apparatus as claimed in claim 15, wherein the first and/or second wireless communication module replies to a query sent by the host device after the shared interrupt signal is received by the host device signal, and then the interrupt source communicates with a respective driver module in the host device in response to a driving signal.

20. The multi-interface communication apparatus as claimed in claim 16, further comprising:
a third transmission interface, arranged to receive a first interrupt signal from the first wireless communication module and a second interrupt signal from the second wireless communication module, and generate the shared interrupt signal according to the first and the second interrupt signals.

21. The multi-interface communication apparatus as claimed in claim 18, wherein the processor comprises a logic gate for performing a logic operation one the first interrupt signal and the second interrupt signal, and a signal generator coupled to the logic gate, for generating the shared interrupt signal according to the output of the logic gate.
